(19) United States
(12) Patent Application Publication
(10) Pub. No.: US 2025/0262735 A1
(43) Pub. Date: Aug. 21, 2025

(54) POWERED FASTENER DRIVER

(71) Applicant: MILWAUKEE ELECTRIC TOOL CORPORATION, Brookfield, WI (US)

(72) Inventors: Kevin R. Broda, Waukesha, WI (US); Coby A. Nettleton, Milwaukee, WI (US)

(21) Appl. No.: 19/056,877

(22) Filed: Feb. 19, 2025

Related U.S. Application Data
(60) Provisional application No. 63/575,133, filed on Apr. 5, 2024.
(60) Provisional application No. 63/555,184, filed on Feb. 19, 2024.

(51) Int. Cl. B25C 1/04; B25C 1/00; B25C 1/06

(52) U.S. Cl. CPC B25C 1/047; B25C 1/06; B25C 1/005

(57) ABSTRACT

A fastener driver may include an inner cylinder centrally defining an inner cylinder axis. A fastener driver may include a piston positioned within the inner cylinder. A fastener driver may include a driver blade coupled to the piston and movable therewith between a ready position and a driven position. A fastener driver may include a storage tank including a large portion centrally defining a large portion axis, the large portion surrounding at least a portion of the inner cylinder. A fastener driver may include a housing supporting the storage tank and including a handle portion, the handle portion defining a handle portion axis extending transverse to the inner cylinder axis, wherein the inner cylinder axis extends within a dividing plane that centrally and longitudinally divides the inner cylinder into a first half and a second half.

### CROSS-REFERENCE TO RELATED APPLICATIONS

This application claims priority to U.S. Provisional Patent Application No. 63/575,133, filed Apr. 5, 2024, and to U.S. Provisional Patent Application No. 63/555,184, filed Feb. 19, 2024, the entire contents of all of which are incorporated herein by reference.

### FIELD OF THE DISCLOSURE

The present disclosure relates to power tools, and more particularly to gas spring-powered fastener drivers.

### BACKGROUND OF THE DISCLOSURE

Hardware, such as, joist hangers, straps, hurricane ties, etc., are typically attached with fasteners (e.g., nails) to building frames, studs, beams, joists, etc. Typically, such fasteners are driven into a workpiece by a powered fastener driver. The fasteners are collated into a strip and positioned within a magazine of the powered fastener driver.

### SUMMARY OF THE DISCLOSURE

The present disclosure provides, in one aspect, a fastener driver including: an inner cylinder centrally defining an inner cylinder axis; a piston positioned within the inner cylinder; a driver blade coupled to the piston and movable therewith between a ready position and a driven position; a storage tank including a large portion centrally defining a large portion axis, the large portion surrounding at least a portion of the inner cylinder; a housing supporting the storage tank and including a handle portion, the handle portion defining a handle portion axis extending transverse to the inner cylinder axis; wherein the inner cylinder axis extends within a dividing plane that centrally and longitudinally divides the inner cylinder into a first half and a second half; wherein one of: (a) the dividing plane is parallel to the handle portion axis; or (b) the handle portion axis extends within the dividing plane; and wherein the large portion axis is offset from the dividing plane by a distance D that is greater than or equal to 1.0 mm.

In some aspects, the techniques described herein relate to a fastener driver, wherein the distance D is greater than or equal to 5.0 mm.

In some aspects, the techniques described herein relate to a fastener driver, further including a lifter operable to move the driver blade from the driven position to the ready position, wherein the lifter is positioned on a first side of the driver blade, and wherein the distance D is measured in a direction from the inner cylinder axis toward the first side.

In some aspects, the techniques described herein relate to a fastener driver, wherein the large portion is generally cylindrical.

In some aspects, the techniques described herein relate to a fastener driver, wherein the distance D is measured along an offset axis which extends transverse to the inner cylinder axis and transverse to the handle portion axis.

In some aspects, the techniques described herein relate to a fastener driver, wherein the handle portion axis is centrally defined by the handle portion and extends along a length of the handle portion, and wherein the handle portion axis intersects the large portion axis.

In some aspects, the techniques described herein relate to a fastener driver, further including: a lifter operable to move the driver blade from the driven position to the ready position; wherein the lifter is positioned on a first side of the driver blade; wherein the handle portion axis is centrally defined by the handle portion and extends along a length of the handle portion; and wherein the handle portion axis passes beside the large portion axis on the first side of the driver blade.

The present disclosure provides, in another aspect, a fastener driver including: an inner cylinder centrally defining an inner cylinder axis; a piston positioned within the inner cylinder; a driver blade coupled to the piston and movable therewith between a ready position and a driven position; a storage tank fluidly communicating with the inner cylinder; and a housing supporting the storage tank and including a handle portion, the handle portion defining a handle portion axis extending transverse to the inner cylinder axis; wherein the handle portion axis is offset from the inner cylinder axis.

In some aspects, the techniques described herein relate to a fastener driver, wherein the storage tank includes a large portion surrounding at least a portion of the inner cylinder, the large portion centrally defining a large portion axis, and wherein the large portion axis is offset from the inner cylinder axis by a distance D measured along an offset axis which extends transverse to the inner cylinder axis and transverse to the handle portion axis, and wherein the distance D is greater than or equal to 1.0 mm and less than or equal to 40.0 mm.

In some aspects, the techniques described herein relate to a fastener driver, further including a lifter operable to move the driver blade from the driven position to the ready position, wherein the lifter is positioned on a first side of the driver blade, and wherein the distance D is measured in a direction from the inner cylinder axis toward the first side.

In some aspects, the techniques described herein relate to a fastener driver, wherein the housing further includes a battery connection portion connected to the handle portion, the battery connection portion defining a battery portion centerline that extends parallel to the handle portion axis and offset from the handle portion axis, and wherein the handle portion axis extends between the inner cylinder axis and the battery portion centerline.

In some aspects, the techniques described herein relate to a fastener driver, further including: a lifter operable to move the driver blade from the driven position to the ready position; wherein the lifter is positioned on a first side of the driver blade; wherein the handle portion axis is centrally defined by the handle portion and extends along a length of the handle portion; and wherein the storage tank includes a large portion surrounding at least a portion of the inner cylinder, the large portion centrally defining a large portion axis, and wherein the handle portion axis passes beside the large portion axis on the first side of the driver blade.

In some aspects, the techniques described herein relate to a fastener driver, wherein: the inner cylinder axis extends within a dividing plane that centrally divides the inner cylinder into a first half and a second half; the handle portion axis extends parallel to the dividing plane; a storage tank volume is defined between an inner surface of the storage tank and an outer surface of the inner cylinder; the dividing plane divides the storage tank volume into a first volume and a second volume; and the first volume is at least 5 percent greater than the second volume.

In some aspects, the techniques described herein relate to a fastener driver, further including: a cap dividing an open end of the inner cylinder from an open end of the storage tank; a first seal positioned between the cap and the inner cylinder; and a nut coupled to the open end of the storage tank and securing the cap to the storage tank.

The present disclosure provides, in another aspect, a fastener driver including: an inner cylinder centrally defining an inner cylinder axis, the inner cylinder axis extending within a dividing plane which centrally divides the inner cylinder into a first half and a second half; a piston positioned within the inner cylinder; a driver blade coupled to the piston and movable therewith between a ready position and a driven position; a storage tank surrounding at least a portion of the inner cylinder; a housing supporting the storage tank and including a handle portion, the handle portion defining a handle portion axis extending transverse to the inner cylinder axis and one of: (a) within the dividing plane, and (b) parallel to the dividing plane; wherein a storage tank volume is defined between an inner surface of the storage tank and an outer surface of the inner cylinder; wherein the dividing plane divides the storage tank volume into a first volume and a second volume; and wherein the first volume differs from the second volume by at least 5 percent.

In some aspects, the techniques described herein relate to a fastener driver, wherein the first volume is at least 20 percent greater than the second volume.

In some aspects, the techniques described herein relate to a fastener driver, wherein the storage tank includes a large diameter portion surrounding at least the portion of the inner cylinder, the large diameter portion centrally defining a large diameter portion axis, and wherein the large diameter portion axis is offset from the inner cylinder axis by a distance D that is greater than or equal to 1.0 mm.

In some aspects, the techniques described herein relate to a fastener driver, wherein: the storage tank includes a large diameter portion surrounding at least the portion of the inner cylinder, the large diameter portion centrally defining a large diameter portion axis; the handle portion axis is centrally defined by the handle portion and extends along a length of the handle portion; and the handle portion axis intersects the large diameter portion axis.

In some aspects, the techniques described herein relate to a fastener driver, further including: a lifter operable to move the driver blade from the driven position to the ready position; wherein the lifter is positioned on a first side of the driver blade; wherein the storage tank includes a large diameter portion surrounding at least the portion of the inner cylinder, the large diameter portion centrally defining a large diameter portion axis; wherein the handle portion axis is centrally defined by the handle portion and extends along a length of the handle portion; and wherein the handle portion axis passes beside the large diameter portion axis on the first side of the driver blade.

In some aspects, the techniques described herein relate to a fastener driver, further including: a cap dividing an open end of the inner cylinder from an open end of the storage tank; a first seal positioned between the cap and the inner cylinder; and a nut coupled to the open end of the storage tank and securing the cap to the storage tank.

Other features and aspects of the disclosure will become apparent by consideration of the following detailed description and accompanying drawings.

### BRIEF DESCRIPTION OF THE DRAWINGS

FIG. 1 is a perspective view of a gas spring-powered fastener driver in accordance with an embodiment of the disclosure.

FIG. 2 is a cross-sectional view of the fastener driver of FIG. 1, taken along line 2-2 of FIG. 1.

FIG. 2A is a perspective view of a storage tank of the fastener driver of FIG. 1.

FIG. 2B is a cross-sectional view of the storage tank of FIG. 2A, taken along line 2B-2B of FIG. 2A.

FIG. 2C is another cross-sectional view of the storage tank of FIG. 2A, taken along line 2C-2C of FIG. 2A.

FIG. 3 is a partially exploded view illustrating portions of the fastener driver of FIG. 1.

FIG. 4 is detailed cross-sectional view illustrating portions of the fastener driver of FIG. 1, taken along line 2-2 of FIG. 1.

FIG. 5 is a cross-sectional view illustrating portions of the fastener driver of FIG. 1, taken along line 5-5 of FIG. 1.

FIG. 6 is another cross-sectional view illustrating portions of the fastener driver of FIG. 1, taken along line 5-5 of FIG. 1, according to another embodiment of the disclosure.

FIG. 7 is another cross-sectional view of the fastener driver of FIG. 1, taken along line 6-6 of FIG. 1.

FIG. 8 is rear end view of the fastener driver of FIG. 1.

FIG. 9 is a rear end view of a fastener driver according to another embodiment of the disclosure.

Before any embodiments of the disclosure are explained in detail, it is to be understood that the disclosure is not limited in its application to the details of construction and the arrangement of components set forth in the following description or illustrated in the following drawings. The disclosure is capable of other embodiments and of being practiced or of being carried out in various ways. Also, it is to be understood that the phraseology and terminology used herein is for the purpose of description and should not be regarded as limiting.

### DETAILED DESCRIPTION

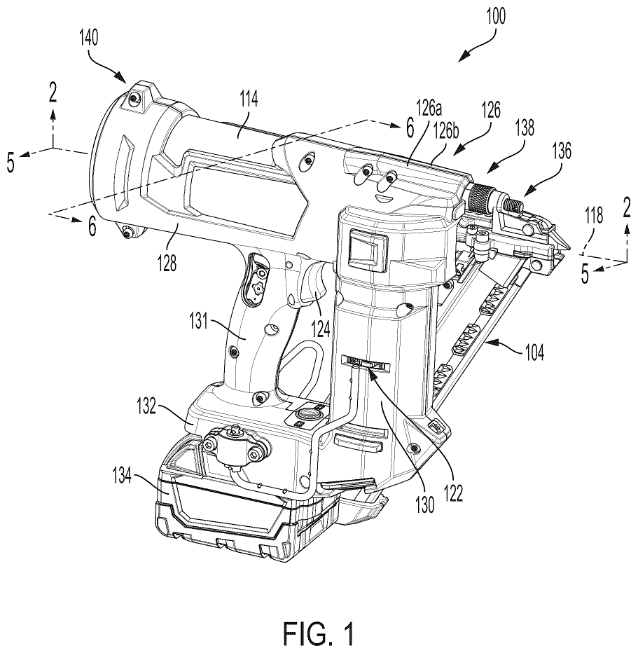

FIGS. 1-3 illustrate a power tool, such as a gas spring-powered fastener driver 100, operable to drive fasteners (e.g., nails, tacks, staples, etc.) held within a magazine 104 into a workpiece. The fastener driver 100 is configured as a multi-shot powered nailer including the magazine 104 holding a collated strip of nails, allowing the user to perform multiple fastening operations without having to manually reload the fastener driver after each driving cycle. In other embodiments, the fasteners can instead be embodied as staples, brads, etc.

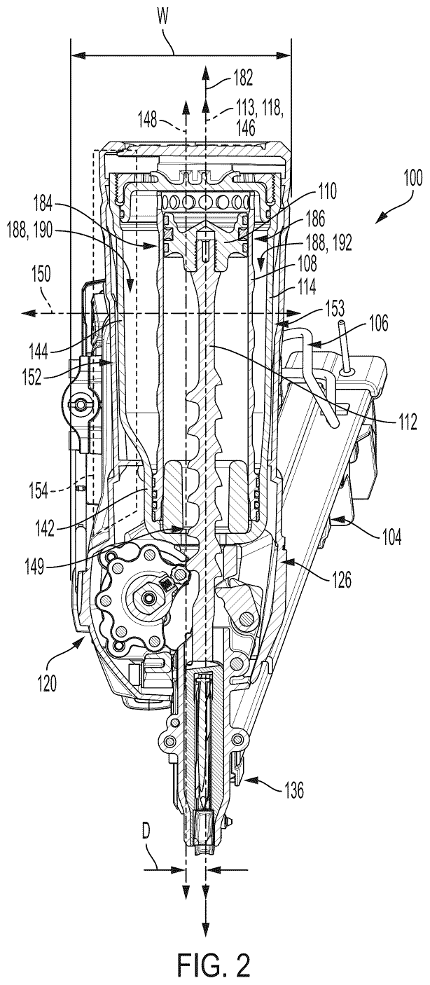

With reference to FIG. 2, the gas spring-powered fastener driver 100 includes a gas spring assembly 106 having an inner cylinder 108 and a moveable piston 110 positioned within the inner cylinder 108. The fastener driver 100 further includes a driver blade 112 that is attached to the piston 110 and moveable therewith. The fastener driver 100 does not require an external source of air pressure, but rather, the gas spring assembly 106 includes a storage tank 114 of pressurized gas in fluid communication with the inner cylinder 108. In the illustrated embodiment, the inner cylinder 108 and moveable piston 110 are positioned within the storage tank 114.

The driver blade 112 defines a driving axis 118. During a driving cycle, the driver blade 112 and the piston 110 are moveable along the driving axis 118 between a ready position (i.e., top dead center) and a driven position (i.e., bottom dead center, as shown in FIG. 2). The inner cylinder 108 centrally defines an inner cylinder axis 113. In the illustrated embodiment, the inner cylinder axis 113 is coaxial with the driving axis 118.

The fastener driver 100 further includes a lifter or lifting assembly 120 which is powered by an electric motor 122 (FIG. 1). The lifting assembly 120 is operable to move the driver blade 112 from the driven position to the ready position.

In operation, when the motor 122 is energized, the lifting assembly 120 drives the piston 110 and the driver blade 112 to the ready position. As the piston 110 and the driver blade 112 are moved to the ready position, the gas above the piston 110 and the gas within the storage tank 114 is compressed. The piston 110 and the driver blade 112 are then held in the ready position until released by user activation of a trigger 124 (FIG. 1). When released, the compressed gas above the piston 110 and within the storage tank 114 drives the piston 110 and the driver blade 112 to the driven position, thereby driving the nail into the workpiece. The illustrated fastener driver 100 therefore operates on a gas spring principle, utilizing the lifting assembly 120 and the piston 110 to further compress the gas within the inner cylinder 108 and the storage tank 114.

With reference to FIGS. 1 and 2, the fastener driver 100 includes a housing 126 formed from clamshell housing halves 126a, 126b. The housing 126 includes a storage tank support portion 128 (FIG. 1) in which the storage tank 114 is at least partially positioned, and a motor housing portion 130 in which the motor 122 and the lifting assembly 120 are at least partially positioned. The housing 126 further includes a handle portion 131 connected to the storage tank support portion 128, and a battery connection portion 132 located at a base of the handle portion 131. The battery connection portion 132 removably couples to a battery 134 (FIG. 1). When the battery 134 is coupled to the battery connection portion 132, the battery 134 is electrically connected to the motor 122. The battery 134 can supply electrical power to the motor 122 and other electrical components of the fastener driver 100. In alternative embodiments, the driver may be powered from an AC voltage input (i.e., from a wall outlet), or by an alternative DC voltage input (e.g., a DC power support).

With reference to FIG. 1, the fastener driver 100 further includes a nosepiece assembly 136 that is supported at a first end 138 of the housing 126. During the driving operation, the driver blade 112 ejects the fastener through the nosepiece assembly 136 and into the workpiece. The storage tank support portion 128 of the housing 126 defines a second end 140 that is located opposite from the first end 138 along a direction of the driving axis 118.

With reference to FIGS. 2-2C, the storage tank 114 includes a small portion 142 and a large portion 144. The small portion 142 has a cross-sectional area A1 (FIG. 2B), measured along a cutting plane 2B-2B extending perpendicular to the small portion central axis 146 and the driving axis 118. The large portion 144 has a cross-sectional area A2 (FIG. 2C), measured along a cutting plane 2C-2C extending perpendicular to the small portion central axis 146 and the driving axis 118. The cross-sectional area A1 is smaller than the cross-sectional area A2. In the illustrated embodiment, each of the small portion 142 and the large portion 144 is generally cylindrical in shape. In other embodiments, one or both portions 142, 144 may instead be non-cylindrical (e.g., somewhat frustoconical, or having an ovoid cross-section, or a non-symmetrical cross-section). The small portion 142 is positioned adjacent the nosepiece assembly 136 and the lifting assembly 120 and centrally defines a small portion central axis 146. The small portion central axis 146 is coaxial with the inner cylinder axis 113 and the driving axis 118 in the illustrated embodiment. As such, the small portion 142 is arranged concentrically about the inner cylinder 108. The large portion 144 is adjacent the second end 140 and centrally defines a large portion central axis 148. In the illustrated embodiment shown in FIG. 2, the large portion central axis 148 is laterally offset from the inner cylinder axis 113 in a direction toward the lifting assembly 120. As such, the large portion 144 is non-concentric with the inner cylinder 108. The large portion 144 surrounds at least a portion of the inner cylinder 108.

Because the inner cylinder axis 113, the driving axis 118, and the small portion central axis 146 are all coaxial in the illustrated embodiment, the large portion central axis 148 is also laterally offset from the driving axis 118 and the small portion central axis 146. An offset distance D is measured perpendicularly between the inner cylinder axis 113 and the large portion central axis 148. In the illustrated embodiment, the offset distance D measures 8.5 millimeters (mm). In other embodiments, the offset distance D is greater than or equal to 1.0 mm. In further embodiments, the offset distance D is greater than or equal to 1.0 mm and less than or equal to 40.0 mm. In other embodiments, the offset distance D is greater than or equal to 5.0 mm and less than or equal to 40.0 mm. In further embodiments, the offset distance D is greater than or equal to 5.0 mm and less than or equal to 30.0 mm.

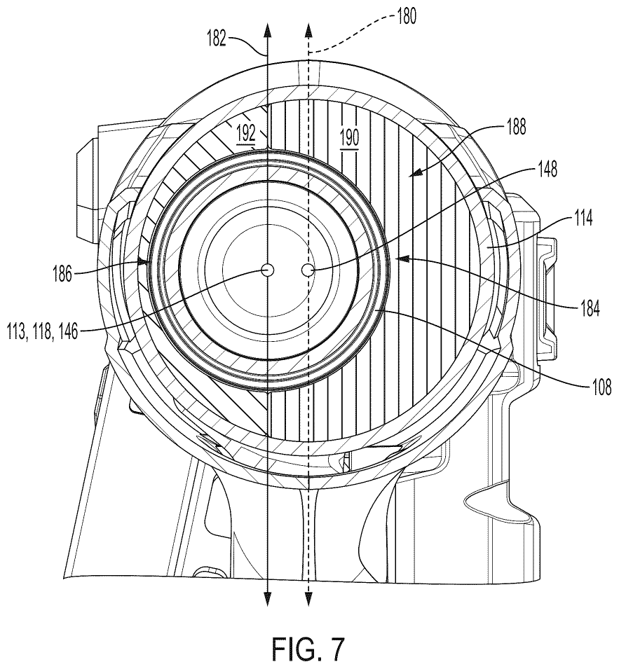

As shown in FIG. 2, the lifting assembly 120 is positioned on a first side 149 of the driver blade 112. The offset distance D is measured in a direction from the inner cylinder axis 113 toward the first side 149. The offset distance D is also measured along, or parallel to, an offset axis 150 which extends transverse to the inner cylinder axis 113 (see also FIG. 7).

With continued reference to FIG. 2, the large portion 144 of the storage tank 114 defines a bulge portion 152 on one lateral side thereof and defines a straight portion 153 on an opposite lateral side thereof. The bulge portion 152 generally protrudes into a space 154 located behind the lifting assembly 120 and above the battery connection portion 132. The lifting assembly 120 is located laterally beside the driver blade 112, which enables the lifting assembly 120 to rotatably engage the driver blade 112. In many traditional gas spring-powered fastener drivers, the inner cylinder and the outer cylinder are concentrically arranged, leaving the space behind the lifting assembly substantially unoccupied. In the illustrated fastener driver 100, the space 154 is substantially occupied by the bulge portion 152. This reduces an overall form factor or width W of the of the fastener driver 100 and improves a user's lines of sight toward the nosepiece assembly 136 and the workpiece during use. The width W is measured between the widest portions of the housing 126 in a direction perpendicular to the driving axis 118.

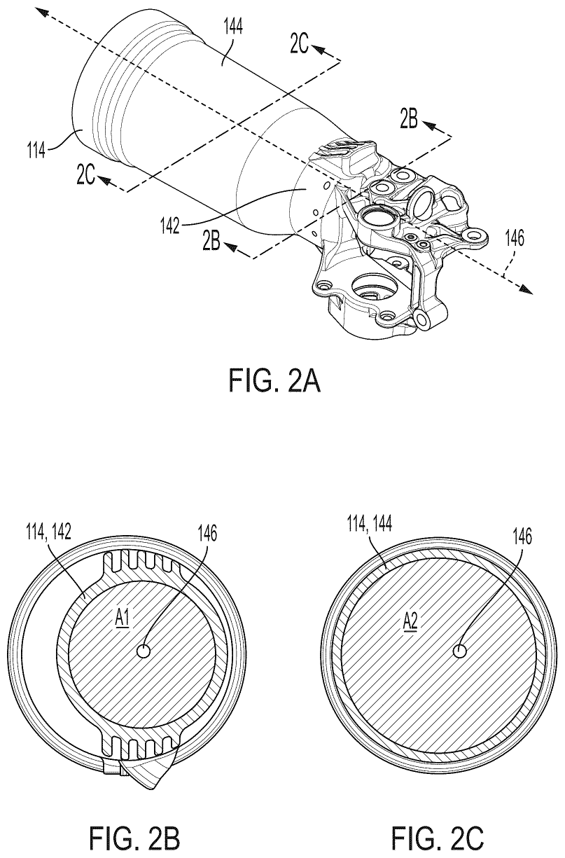

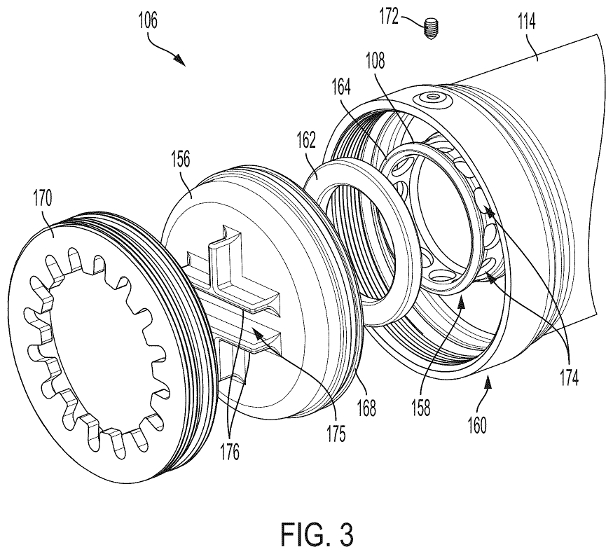

With reference to FIGS. 3-5, the gas spring assembly 106 also includes a cap 156 positioned adjacent the second end 140 of the housing 126. The cap 156 functions as a barrier to partially divide an interior space within the inner cylinder 108 from an exterior space defined between an exterior surface of the inner cylinder 108 and an interior surface of the storage tank 114. Each of the inner cylinder 108 and the storage tank 114 define respective open ends 158, 160 located adjacent the second end 140 of the housing 126. The cap 156 resides within the open end 160 of the storage tank 114 and separates the open end 160 from the open end 158 of the inner cylinder 108. An inner seal 162 is positioned between a rim 164 of the open end 158 of the inner cylinder 108 and an inner surface 166 of the cap 156. The inner seal 162 creates an air-tight seal between the rim 164 and the inner surface 166, and can be made from, e.g., a relatively flexible material such as an elastomer (e.g., rubber). An outer seal 168 (e.g., an O-ring) is positioned between the cap 156 and the storage tank 114 adjacent the open end 160 thereof. The outer seal 168 creates an air-tight seal between the cap 156 and the storage tank 114, and can likewise be made from, e.g., a relatively flexible material such as an elastomer (e.g., rubber).

As shown in FIGS. 3-5, the cap 156 is generally cup-shaped and has a circular profile corresponding to the circular shape of the open end 160 of the storage tank 114. However, due to the positioning of the bulge portion 152 relative to the inner cylinder 108, the cap 156 is non-concentric with the rim 164 of the inner cylinder 108. Thus, a separate, externally-threaded nut 170 secures the cap 156 to the storage tank 114. The external threads of the nut 170 engage internal threads formed at the open end 160 of the storage tank 114. Tightening the externally-threaded nut 170 forces the cap 156 toward the rim 164, causing the inner seal 162 to compress. This ensures the integrity of the seal formed between the cap 156 and the rim 164. When the externally-threaded nut 170 is sufficiently tightened, a set screw 172 threads and tightens into a wall of the storage tank 114 and abuts the cap 156 to hold the cap 156 in place.

As shown in FIG. 3, the inner cylinder 108 defines a plurality of apertures 174 near the rim 164 at the open end 158 of the inner cylinder 108. The apertures 174 communicate the interior space of the inner cylinder 108 with the exterior space of the storage tank 114 and allow the pressurized gas to flow therebetween.

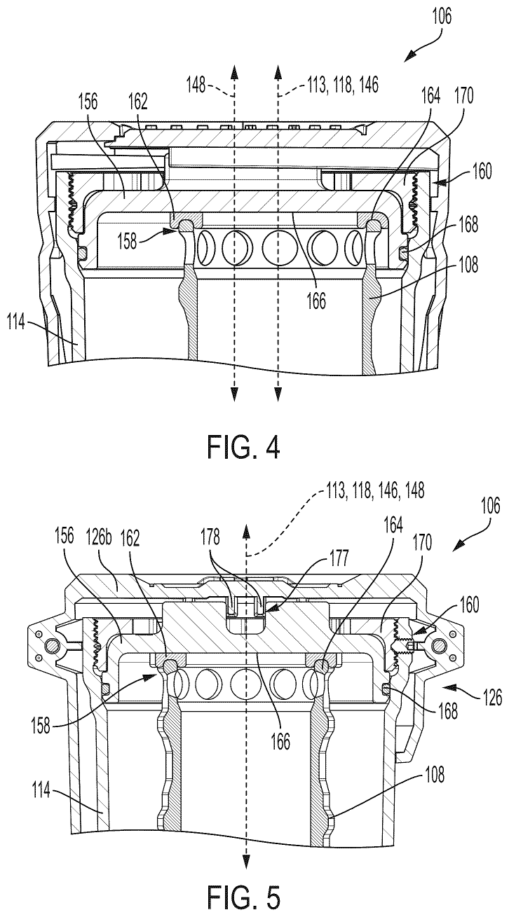

With reference to FIGS. 3 and 5, the housing 126 engages the cap 156 to maintain a correct orientation and position of the cap 156 relative to the inner cylinder 108 and the storage tank 114. As shown in FIG. 3, in the illustrated embodiment, the cap 156 includes a keyway 175 in the form of a slot or a channel. The keyway 175 is defined by a pair of protruding first ribs 176 which extend generally parallel to one another. As shown in FIG. 5, the housing 126 (specifically, the clamshell housing half 126b) includes a key 177 which includes a pair of protruding second ribs 178 extending generally parallel to one another. The key 177 is closely received within the keyway 175 such that the second ribs 178 contact, or nearly contact, the first ribs 176. Engagement between the key 177 and the keyway 175 ensures a correct orientation and position of the cap 156 relative to the inner cylinder 108 and the storage tank 114 during assembly of the fastener driver 100, and further prevents the cap 156 from moving away from this correct position during use.

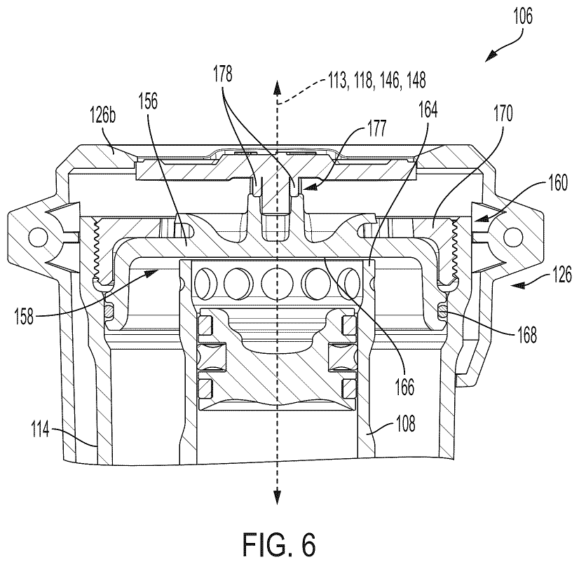

With reference to FIG. 6, in another embodiment of the fastener driver 100, the inner seal 162 may be omitted from the assembly. The embodiment of FIG. 6 is substantially similar to the embodiment of FIGS. 1-5, except the inner seal 162 is omitted such that the rim 164 directly abuts (or, is nominally spaced apart from) the inner surface 166 of the cap 156.

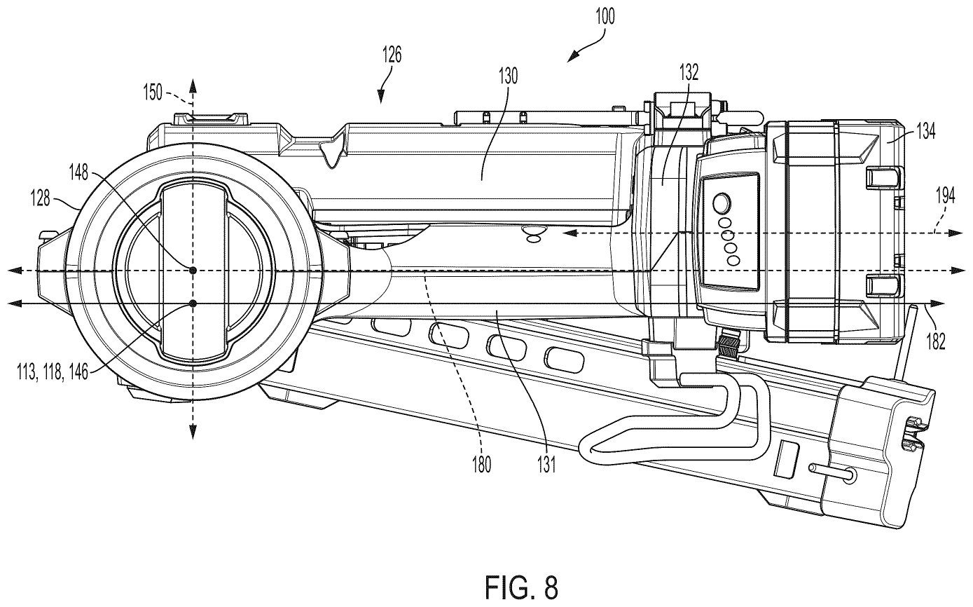

With reference to FIGS. 7 and 8, the handle portion 131 centrally defines a handle portion axis 180 which extends along a length of the handle portion 131. In the illustrated embodiment, the handle portion axis 180 extends perpendicular to the driving axis 118 and perpendicular to the inner cylinder axis 113. In other embodiments, the handle portion axis 180 extends transverse to the inner cylinder axis 113 but may not extend perpendicular thereto. The handle portion axis 180 also extends transverse to the offset axis 150 (FIG. 2). In the illustrated embodiment, the handle portion axis 180 is in line with the large portion central axis 148. Moreover, the handle portion axis 180 intersects the large portion central axis 148 in the illustrated embodiment. As such, the handle portion 131 is generally centered beneath the large portion 144. Because the handle portion axis 180 extends perpendicular to the driving axis 118 and intersects the large portion central axis 148, the handle portion axis 180 is also laterally offset from the inner cylinder axis 113 by the offset distance D.

Referring to FIGS. 2, and 6, 7, and 8, the inner cylinder axis 113 extends within a dividing plane 182 that centrally divides the inner cylinder 108 into a first half 184 and a second half 186. In the illustrated embodiment, dividing plane 182 extends parallel to the handle portion axis 180. In other embodiments (not shown), the handle portion axis 180 may extend within the dividing plane 182. In the illustrated embodiment, storage tank volume 188 is defined between an inner surface of the storage tank 114 and an outer surface of the inner cylinder 108. The dividing plane 182 divides the storage tank volume 188 into a first volume 190 and a second volume 192. In the illustrated embodiment, the first volume 190 is greater than the second volume 192. In particular, the first volume is at least 5 percent greater than the second volume 192. In some embodiments, the first volume is at least 20 percent greater than the second volume 192. The first volume 190 is located on a same side of the dividing plane 182 as the lifting assembly 120. In other embodiments, the first volume differs from the second volume by at least five percent. In other embodiments, the first volume differs from the second volume by at least 20 percent.

With continued reference to FIG. 8, the battery connection portion 132 defines a battery centerline 194 extending parallel to the handle portion axis 180 and parallel to the dividing plane 182. When the battery 134 is attached to the battery connection portion 132, the battery centerline 194 bisects the battery 134 into two equal halves. The battery centerline 194 is laterally offset from the handle portion axis 180 in a direction toward the lifting assembly (not shown), and toward the motor housing portion 130. The battery centerline 194 is also laterally offset from handle portion axis 180 in a direction away from the dividing plane 182 and away from the inner cylinder axis 113. By laterally offsetting the battery centerline 194 relative to the handle portion axis 180 in this manner, the form factor or width W of the of the fastener driver 100 (FIG. 2) is minimized. This is because the battery 134 is displaced toward the space 154 (FIG. 2), therefore the battery 134 (particularly for larger battery packs) is less likely to protrude laterally beyond the edge of the storage tank support portion 128 of the housing 126 (i.e., in a direction toward the magazine 104).

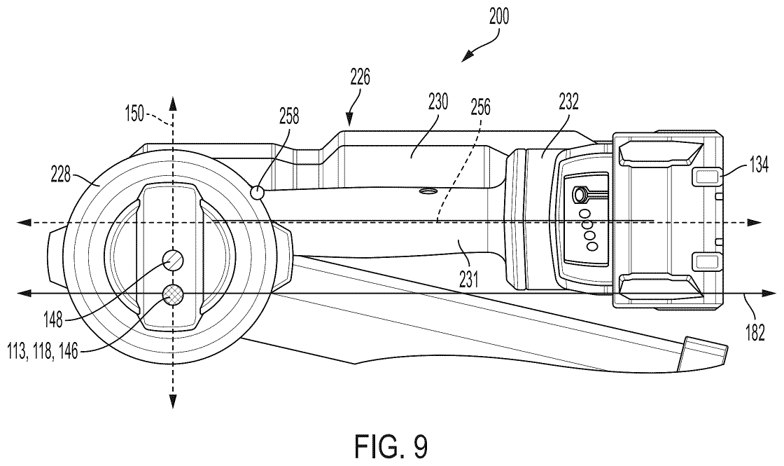

FIG. 9 illustrates a fastener driver 200 that is similar to the fastener driver 100, with like features having like reference numbers “plus 100”. As shown in FIG. 8, the fastener driver 200 includes a housing 226 with a storage tank support portion 228, a motor housing portion 230, a handle portion 231, and a battery connection portion 232. Although not shown in FIG. 8, the fastener driver 200 includes a driver blade, an inner cylinder, and storage tank substantially the same as the driver blade 112, the inner cylinder 108, and the storage tank 114 described herein, and defining the same respective axes 113, 118, 146, and 148. The handle portion 231 centrally defines a handle portion axis 256 that extends perpendicular to the driving axis 118. However, the handle portion 231 is not arranged in line with the large diameter portion of the storage tank. Instead, the handle portion 231 is offset from the large diameter portion, and as such, the handle portion axis 256 is laterally offset from the large portion central axis 148 in a direction toward the lifting assembly (not shown), and toward the motor housing portion 130. The handle portion axis 256 also passes beside the large portion central axis 148 on the first side 149 (FIG. 2) of the driver blade 112, and passes beside the inner cylinder axis 113 on the first side 149. The handle portion 231 is also arranged in line with the battery connection portion 232. The fastener driver 200 includes a center of gravity (CG) 258 shown in FIG. 9. Compared to the fastener driver 100, the handle portion axis 256 of the fastener driver 200 is positioned relatively closer to the CG 258 due to its lateral offset relative to the large portion central axis 148.

In the embodiment shown in FIG. 9, the inner cylinder axis 113 extends within the dividing plane 182 which centrally divides the inner cylinder 108 into a first half 184 and a second half 186 (see FIG. 2). However, because the handle portion axis 256 is offset from the large portion central axis 148, the handle portion axis 256 does not extend within the dividing plane 182. Instead, the dividing plane 182 extends parallel to the handle portion axis 256 in the illustrated embodiment.

Although the disclosure has been described in detail with reference to certain preferred embodiments, variations and modifications exist within the scope and spirit of one or more independent aspects of the disclosure as described.

Various features of the disclosure are set forth in the following claims.

1. A fastener driver comprising:
an inner cylinder centrally defining an inner cylinder axis;
a piston positioned within the inner cylinder;
a driver blade coupled to the piston and movable therewith between a ready position and a driven position;
a storage tank including a large portion centrally defining a large portion axis, the large portion surrounding at least a portion of the inner cylinder;
a housing supporting the storage tank and including a handle portion, the handle portion defining a handle portion axis extending transverse to the inner cylinder axis;
wherein the inner cylinder axis extends within a dividing plane that centrally and longitudinally divides the inner cylinder into a first half and a second half;
wherein one of:
a) the dividing plane is parallel to the handle portion axis; or
b) the handle portion axis extends within the dividing plane; and
wherein the large portion axis is offset from the dividing plane by a distance D that is greater than or equal to 1.0 mm.

2. The fastener driver of claim 1, wherein the distance D is greater than or equal to 5.0 mm.

3. The fastener driver of claim 2, further comprising a lifter operable to move the driver blade from the driven position to the ready position, wherein the lifter is positioned on a first side of the driver blade, and wherein the distance D is measured in a direction from the inner cylinder axis toward the first side.

4. The fastener driver of claim 3, wherein the large portion is generally cylindrical.

5. The fastener driver of claim 1, wherein the distance D is measured along an offset axis which extends transverse to the inner cylinder axis and transverse to the handle portion axis.

6. The fastener driver of claim 5, wherein the handle portion axis is centrally defined by the handle portion and extends along a length of the handle portion, and wherein the handle portion axis intersects the large portion axis.

7. The fastener driver of claim 5, further comprising:
a lifter operable to move the driver blade from the driven position to the ready position;
wherein the lifter is positioned on a first side of the driver blade;
wherein the handle portion axis is centrally defined by the handle portion and extends along a length of the handle portion; and
wherein the handle portion axis passes beside the large portion axis on the first side of the driver blade.

8. A fastener driver comprising:
an inner cylinder centrally defining an inner cylinder axis;
a piston positioned within the inner cylinder;
a driver blade coupled to the piston and movable therewith between a ready position and a driven position;
a storage tank fluidly communicating with the inner cylinder; and
a housing supporting the storage tank and including a handle portion, the handle portion defining a handle portion axis extending transverse to the inner cylinder axis;
wherein the handle portion axis is offset from the inner cylinder axis.

9. The fastener driver of claim 8, wherein the storage tank includes a large portion surrounding at least a portion of the inner cylinder, the large portion centrally defining a large portion axis, and wherein the large portion axis is offset from the inner cylinder axis by a distance D measured along an offset axis which extends transverse to the inner cylinder axis and transverse to the handle portion axis, and wherein the distance D is greater than or equal to 1.0 mm and less than or equal to 40.0 mm.

10. The fastener driver of claim 9, further comprising a lifter operable to move the driver blade from the driven position to the ready position, wherein the lifter is positioned on a first side of the driver blade, and wherein the distance D is measured in a direction from the inner cylinder axis toward the first side.

11. The fastener driver of claim 8, wherein the housing further includes a battery connection portion connected to the handle portion, the battery connection portion defining a battery portion centerline that extends parallel to the handle portion axis and offset from the handle portion axis, and wherein the handle portion axis extends between the inner cylinder axis and the battery portion centerline.

12. The fastener driver of claim 8, further comprising:
a lifter operable to move the driver blade from the driven position to the ready position;
wherein the lifter is positioned on a first side of the driver blade;
wherein the handle portion axis is centrally defined by the handle portion and extends along a length of the handle portion; and
wherein the storage tank includes a large portion surrounding at least a portion of the inner cylinder, the large portion centrally defining a large portion axis, and
wherein the handle portion axis passes beside the large portion axis on the first side of the driver blade.

13. The fastener driver of claim 8, wherein:
the inner cylinder axis extends within a dividing plane that centrally divides the inner cylinder into a first half and a second half;
the handle portion axis extends parallel to the dividing plane;
a storage tank volume is defined between an inner surface of the storage tank and an outer surface of the inner cylinder;
the dividing plane divides the storage tank volume into a first volume and a second volume; and
the first volume is at least 5 percent greater than the second volume.

14. The fastener driver of claim 8, further comprising:
a cap dividing an open end of the inner cylinder from an open end of the storage tank;
a first seal positioned between the cap and the inner cylinder; and
a nut coupled to the open end of the storage tank and securing the cap to the storage tank.

15. A fastener driver comprising:
an inner cylinder centrally defining an inner cylinder axis, the inner cylinder axis extending within a dividing plane which centrally divides the inner cylinder into a first half and a second half;
a piston positioned within the inner cylinder;
a driver blade coupled to the piston and movable therewith between a ready position and a driven position;
a storage tank surrounding at least a portion of the inner cylinder;
a housing supporting the storage tank and including a handle portion, the handle portion defining a handle portion axis extending transverse to the inner cylinder axis and one of: (a) within the dividing plane, and (b) parallel to the dividing plane;
wherein a storage tank volume is defined between an inner surface of the storage tank and an outer surface of the inner cylinder;
wherein the dividing plane divides the storage tank volume into a first volume and a second volume; and
wherein the first volume differs from the second volume by at least 5 percent.

16. The fastener driver of claim 15, wherein the first volume is at least 20 percent greater than the second volume.

17. The fastener driver of claim 15, wherein the storage tank includes a large diameter portion surrounding at least the portion of the inner cylinder, the large diameter portion centrally defining a large diameter portion axis, and wherein the large diameter portion axis is offset from the inner cylinder axis by a distance D that is greater than or equal to 1.0 mm.

18. The fastener driver of claim 15, wherein:
the storage tank includes a large diameter portion surrounding at least the portion of the inner cylinder, the large diameter portion centrally defining a large diameter portion axis;
the handle portion axis is centrally defined by the handle portion and extends along a length of the handle portion; and
the handle portion axis intersects the large diameter portion axis.

19. The fastener driver of claim 15, further comprising:
a lifter operable to move the driver blade from the driven position to the ready position;
wherein the lifter is positioned on a first side of the driver blade;
wherein the storage tank includes a large diameter portion surrounding at least the portion of the inner cylinder, the large diameter portion centrally defining a large diameter portion axis;
wherein the handle portion axis is centrally defined by the handle portion and extends along a length of the handle portion; and
wherein the handle portion axis passes beside the large diameter portion axis on the first side of the driver blade.

20. The fastener driver of claim 15, further comprising:
a cap dividing an open end of the inner cylinder from an open end of the storage tank;
a first seal positioned between the cap and the inner cylinder; and
a nut coupled to the open end of the storage tank and securing the cap to the storage tank.
